(19) United States
(12) Patent Application Publication
(10) Pub. No.: US 2026/0063147 A1
(43) Pub. Date: Mar. 5, 2026

(54) PUMP WITH BUSHING AND DAMPENER

(71) Applicant: ElectroSea, LLC, Plymouth, MN (US)

(72) Inventors: Brian Alan GOLDEN, Eden Prairie, MN (US); Peter Samuel Broen FINZELL, Shoreview, MN (US)

(73) Assignee: ElectroSea, LLC, Plymouth, MN (US)

(21) Appl. No.: 19/319,089

(22) Filed: Sep. 4, 2025

Related U.S. Application Data
(60) Provisional application No. 63/691,143, filed on Sep. 5, 2024.

(51) Int. Cl. F04D 29/66; B63H 21/38; F04D 13/06

(52) U.S. Cl. CPC F04D 29/669; B63H 21/383; F04D 13/06

(57) ABSTRACT

The present disclosure relates to a magnetic drive pump including an impeller rotatable about an axis of rotation defined by an impeller shaft. An elastomeric dampener is provided for reducing vibration/heat related damage that may otherwise occur when the pump is operated in a dry state where insufficient liquid is provided for cooling.

### CROSS REFERENCE TO RELATED APPLICATIONS

This application claims benefit to U.S. Provisional Application 63/691,143, filed on Sep. 5, 2024, the disclosure of which is incorporated by reference in its entirety.

### TECHNICAL FIELD

The present disclosure relates generally to pumps such as magnetic drive pumps.

### BACKGROUND

Pumps are used to move fluids (e.g., liquids) through fluid conveyance systems. Certain pumps can be prone to rapid failure due to overheating under conditions in which the pumps are run when lacking sufficient fluid to provide cooling.

### SUMMARY

One aspect of the present disclosure relates to a magnetic drive pump including an impeller rotatable about an axis of rotation defined by an impeller shaft. An elastomeric dampener is provided for reducing vibration related forces that increase friction, wear and/or/heat that can damage the pump particularly when the pump is run in a dry state. In certain examples, the dampener inhibits vibration between the bushing and the impeller shaft. The vibration can be caused by an unbalance of the impeller and the dampener can be configured to inhibit relative vibrational movement between the bushing and the shaft.

Another aspect of the present disclosure relates to a magnetic drive pump including an impeller shaft defining an axis of rotation. The magnetic drive pump includes a magnetically driven assembly configured to rotate about the axis of rotation. The magnetically driven assembly includes an impeller and a first magnet. The magnetic drive pump also includes a bushing positioned on the impeller shaft for supporting rotation of the magnetically driven assembly about the axis of rotation. The magnetic drive pump further includes an elastomeric dampener for resisting relative vibrational movement between the impeller shaft and the bushing.

In one example, the impeller and first magnet are adapted to rotate about the impeller shaft. The bushing and the elastomeric dampener are configured to rotate about the impeller shaft in unison with the impeller and the first magnet. The elastomeric dampener is disposed between the bushing and the impeller. The elastomeric dampener is configured for reducing the likelihood of wear and/or heat related damage which might otherwise occur if the magnetic drive pump is operated under conditions such as dry conditions where insufficient liquid is provided for cooling. The dampener can resist vibration from being transferred from the impeller, magnet assembly, or other rotating elements to the bushing such that relative vibration between the impeller shaft and the bushing is inhibited.

In another example, the magnetic drive pump includes a pump housing, and the impeller and the first plurality of magnets are adapted to rotate with the impeller shaft about the axis of rotation. The impeller shaft is configured to rotate relative to the bushing and the elastomeric dampener about the axis or rotation. The bushing is supported by the pump housing, and the elastomeric dampener is positioned between the bushing and the pump housing. The elastomeric dampener resists relative vibrational movement between the impeller shaft and the bushing by allowing radial movement of the bushing with the shaft.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the examples described herein are based.

### BRIEF DESCRIPTION OF THE DRAWINGS

The accompanying drawings, which are incorporated in and constitute a part of the specification, illustrate aspects of the present disclosure and together with the description, serve to explain the principles of the disclosure. A brief description of the drawings is as follows:

FIG. 1 illustrates a magnetic drive pump in accordance with the principles of the present disclosure;

FIG. 2 illustrates an exploded view of a portion of the magnetic drive pump of FIG. 1;

FIG. 3 illustrates a cross-sectional view of a portion of the magnetic drive pump of FIG. 1;

FIG. 4 illustrates a perspective view of a portion of the magnetic drive pump of FIG. 1;

FIG. 5 depicts another pump dampening configuration in accordance with the principles of the present disclosure; and

FIG. 6 illustrates a watercraft having an on-board water system including a pumping system in accordance with the principles of the present disclosure.

### DETAILED DESCRIPTION

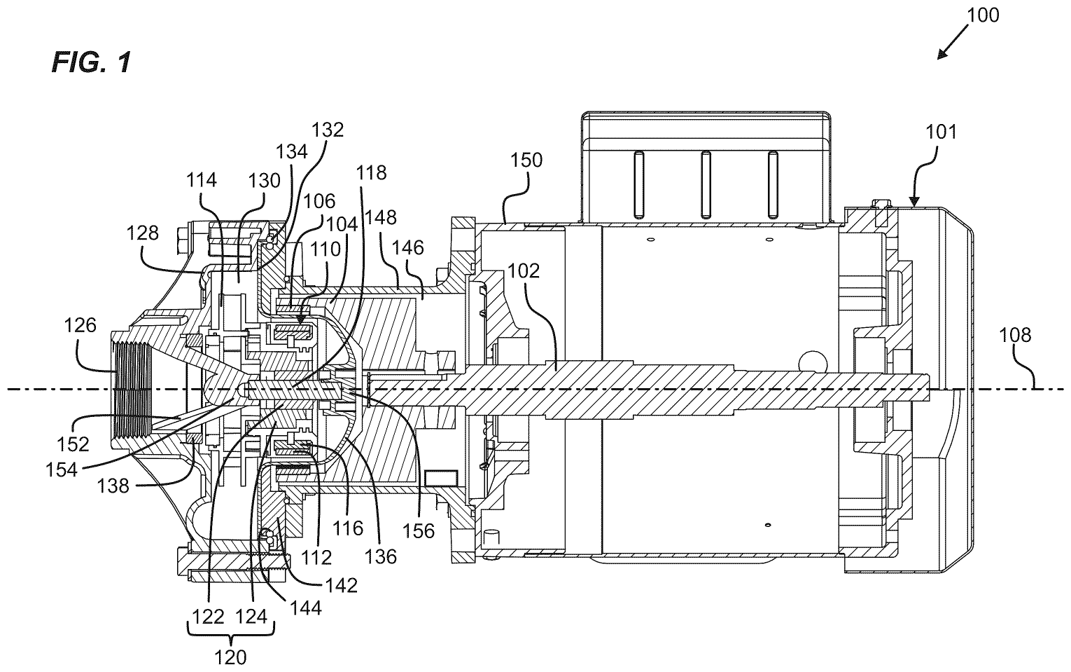

FIG. 1 illustrates a magnetic drive pump 100 in accordance with the principles of the present disclosure. Magnetic drive pump 100 includes a motor 101 having a drive shaft 102 that drives rotation of a magnetic drive housing 104 supporting a plurality of magnets 106 (e.g., permanent magnets). Motor 101 can be, for example, an electric motor. The magnets 106 are supported by the magnetic drive housing 104 circumferentially about an axis of rotation 108 of the drive shaft 102 and the magnetic drive housing 104. The magnets 106 are supported to face radially toward the axis of rotation 108. A mechanical torque transmitting connection is provided between the drive housing 104 and the drive shaft 102 (e.g., a keyed connection; a splined connection; a connection with opposing flats such as a hexagonal interface, etc.). The magnets 106 of the magnetic drive housing 104 are adapted to be magnetically coupled with magnets 112 (e.g., permanent magnets) of a magnet arrangement 110 corresponding to an impeller 114 of the pump 100. The magnet arrangement 110 includes a magnet support body 116 that supports the magnets 112 circumferentially about the axis of rotation 108 with the magnets 112 facing radially away from the axis of rotation 108 and in opposition with respect to the magnets 106 of the magnetic drive housing 104. The magnets 106, 112 provide a magnetic coupling between the magnetic drive housing 104 and the magnet arrangement 110 that allows torque to be magnetically transferred from the magnetic drive housing 104 to the magnet arrangement 110. The magnet support body 116 couples with the impeller 114 (e.g., interlocks with the impeller 114) such that the magnet support body 116 and the impeller 114 are adapted to rotate together in unison about the axis of rotation 108. The magnet support body 116 rotationally mounts on an impeller shaft 118 aligned along the axis of rotation 108. A bushing and dampener assembly 120 is provided between the magnet support body 116 and the impeller shaft 118 for supporting rotation of the magnet support body 116 and the impeller 114 about the impeller shaft 118. The magnet support body 116 and the impeller 114 can be formed of a polymer material.

In the depicted example, the magnets 106, 112 are depicted as sets of magnets each including a plurality of separate permanent magnets spaced circumferentially about the axis of rotation 108. The magnets provide zones of alternating polarity (e.g., alternating north and south poles) spaced circumferentially about the axis of rotation 108. In other examples, radially magnetized ring magnets (e.g., multipole ring magnets) can be used to provides the zones of alternating polarity.

The impeller 114 and the magnets 112 can be part of a magnetically driven assembly that is rotated about the axis of rotation 108 and the impeller shaft 118 by the electric motor 101 through the magnetic drive housing 104. The magnetically driven assembly can also include the magnet support body 116. In the depicted example, the bushing and dampener assembly 120 is also part of the magnetically driven assembly and is configured to rotate in unison with the impeller 114, the magnets 112 and the magnet support body 116 about the impeller shaft 118.

The impeller 114 and the magnet support body 116 can each have a molded plastic/polymeric construction. The impeller shaft 118 can have a metal construction (e.g., stainless steel, titanium or the like) or a ceramic construction. Example polymeric materials of which the impeller 114 and the magnet support body 116 can be made include polypropylene, polyvinyl chloride, polyamide, polycarbonate, and combinations thereof. The polymeric material can be reinforced such as glass fiber reinforced.

The bushing and dampener assembly 120 can include a dampener 124 and a bushing 122. Dampener 124 can include a bore configured to accommodate bushing 122. The dampener 124 can include an elastomer, i.e. an elastomeric material. In an embodiment, the dampener 124 is a unitary body formed of the elastomer. The elastomeric material of dampener 124 can have a hardness that is less than a hardness of the polymer material of magnet support body 116. In an embodiment, the elastomer has a Shore A hardness in a range from 40 to 90. In an embodiment, the elastomer has a Shore A hardness in a range from 40 to 60. In an embodiment, the elastomer has a Shore A hardness in a range from 60 to 70. In an embodiment, the elastomer has a Shore A hardness in a range from 50 to 60. In an embodiment, the elastomer is a material selected for resistance to the fluid being pumped (e.g., sea water, industrial waste-water, solvents, industrial liquids, caustic liquids, corrosive liquids, etc.). The material of the dampener can be resistant to degradation, damage, alteration of mechanical properties, or the like, during prolonged exposure to the fluid being pumped. Non-limiting examples of suitable elastomers for the dampener 124 include silicone, a fluoroelastomer such as FKM, or the like. In the depicted examples, the dampeners and the bushings are positioned within the pump such that the dampeners and the bushings are exposed to the fluid being pumped through the pump.

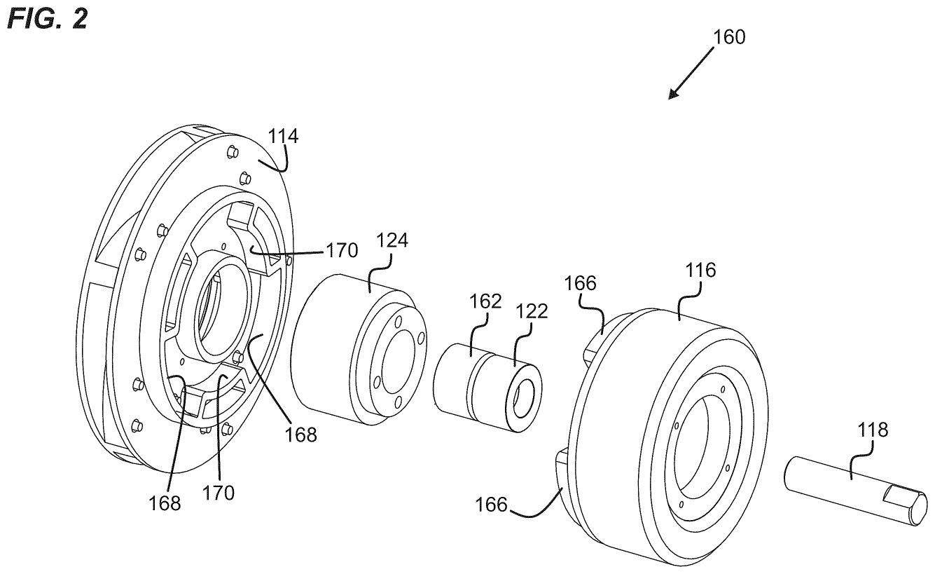

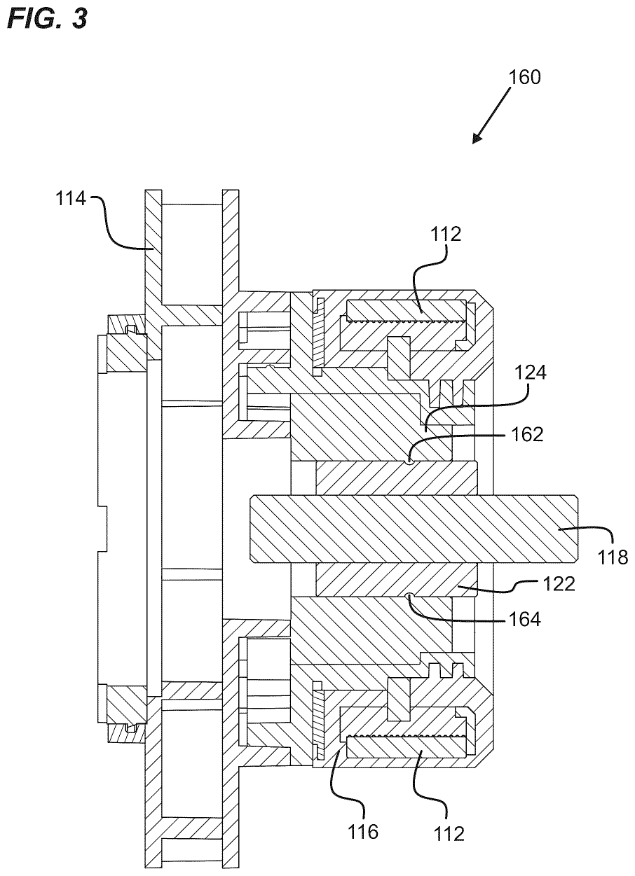

The bushing 122 can be configured to receive the impeller shaft 118 such that bushing 122 can rotate about the impeller shaft 118. In an embodiment, the bushing 122 includes a circumferential groove configured to receive a corresponding projection provided on the dampener 124. The projection and groove are described below and shown in FIGS. 2 and 3. In an embodiment, the bushing 122 can be formed of a material selected from carbon graphite, ceramic, a polymer material, combinations thereof, or the like. In an embodiment, the bushing 122 is formed of carbon graphite. Bushing 122 can include an outer surface configured to be received within dampener 124 and contact inner surfaces of the dampener 124. In an embodiment, the bushing 122 is sized to form a press-fit when received within the bore of dampener 124.

In the depicted example, of FIG. 1, the dampener 124 is a separate piece that couples to the magnet support body 116 such that the dampener 124 and the magnet support body 116 are adapted to rotate together with the bushing 122 about the impeller shaft 118. In an alternative embodiment, the magnet support body 116 or a portion of the magnet support body 116 can itself be made of an elastomeric material so that the magnet support body 116 functions as an elastomeric dampener thereby eliminating the need for an elastomeric dampener separate from the magnet support body. In such as example, the magnet support body can couple directly to the bushing 122. In another embodiment, the dampener 124 can be positioned between the pump housing and the ends of the impeller shaft 118, and the magnet support body 116 and impeller 114 can couple to the rotatable bushing (i.e., a bushing configured to rotate on the shaft 118) without a dampener thereinbetween.

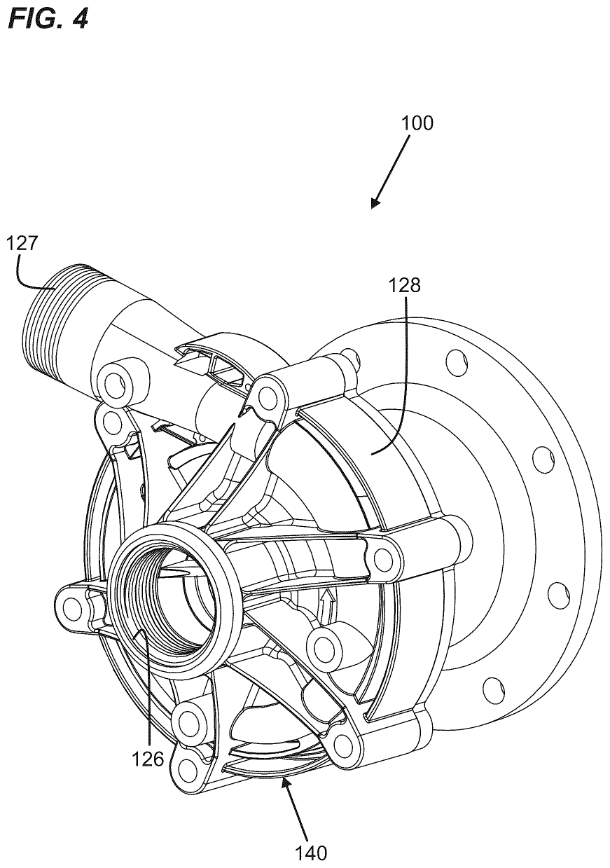

The pump 100 includes an inlet 126, and an outlet 127 as shown in FIG. 4. The inlet 126 can be an axial inlet having an axis that aligns with the axis of rotation 108 and the outlet 127 can be a radial outlet having an axis that is radially oriented relative to the axis of rotation 108. The inlet 126 and the outlet 127 can be defined by a main housing body 128. The main housing body 128 can have a polymeric construction (e.g., being formed of molded plastic). The main housing body 128 can define a pump chamber 130 in which the impeller 114 rotates to pump liquid such as water from the inlet 126 to the outlet 127. Rotation of the impeller 114 is driven by torque from the motor 101 which is transferred to the impeller 114 through the magnetic coupling between the magnetic drive housing 104 and magnet support body 116.

A containment shell 132 attaches to the main housing body 128 in a sealed manner (e.g., via a gasket such as seal 134) to seal the pump chamber 130 and block fluid communication between the magnetic drive housing 104 and the pump chamber 130. In this way, the electric motor and the magnetic drive housing 104 are not exposed to the liquid being pumped through the pump 100. The impeller shaft 118, the bushing and dampener assembly 120, the impeller 114 and the magnet arrangement 110 are all within the pump chamber 130 and exposed to liquid within the pump chamber 130 that is being pumped through the pump chamber 130 by the impeller 114. The liquid being pumped can thereby provide cooling for the parts within the pump chamber 130. The magnet arrangement 110 fits within a sleeve 136 defined by the containment shell 132. The sleeve 136 separates (e.g., mechanically isolates) the magnet arrangement 110 from the magnetic drive housing 104 to prevent liquid from the pump chamber 130 from contacting the electric motor and magnetic drive housing 104; but allows the magnetic coupling of the magnet arrangement 110 and the magnetic drive housing 104 such that torque from the electric motor can be transferred through the magnetic coupling to drive rotation of the magnet arrangement 110 and the impeller 114 about the impeller shaft 118 within the pump chamber 130. A thrust bearing 138 provides a rotational interface between the impeller 114 and the interior of the main housing body 128 to prevent contact between the impeller 114 and the main housing body 128. Opposite ends of the thrust bearing 138 can fit within pockets defined by the main housing body 128 and the impeller 114.

An outer housing 140 of the pump 100 includes the main housing body 128 and a cover 142 that attaches to the main housing body 128 and covers the containment shell 132. A gasket 144 can provide sealing between the cover 142 and the containment shell 132. The cover 142 includes a central opening 146 through which the sleeve 136 extends. The sleeve 136 extends through the opening 146 beyond the cover 142 such that the magnetic drive housing 104 can fit over the sleeve 136 without interference from the cover 142. An outer connection sleeve 148 connects between the cover 142 and a motor housing 150 of the electric motor. The outer connection sleeve 148 covers the magnetic drive housing 104 and opposite ends of the sleeve 136 can be sealed (e.g., with gaskets, O-rings, or the like) with respect to the cover 142 and the motor housing 150.

Opposite ends of the impeller shaft 118 are supported by the main housing body 128 and the containment shell 132. For example, the main housing body 128 includes a support structure including legs 152 extending from the inlet and a sleeve 154 for supporting one end of the impeller shaft 118 and the containment shell 132 includes a support structure including a sleeve 156 for supporting the opposite end of the impeller shaft 118. The main housing body 128, the legs 152, the sleeve 154, the containment shell 132, the cover 142, the sleeve 156, and the magnet support body 116 can all have a polymeric (e.g., plastic) construction and cooperate to define a pump housing of the pump. The impeller shaft 118 can have a metal or ceramic construction. In cases where the pump 100 runs dry for an extended period, the impeller shaft 118, the bushing and dampener assembly 120, and the thrust bearing 138 are not bathed in liquid which can provide cooling. As a result, excessive wear can occur due to heat (e.g., overheating) generated at the bearing interfaces. Such overheating can cause damage (e.g., melting, plastic deformation, etc.) of the adjacent plastic parts such as portions of the main housing body 128, the legs 152, the sleeve 154, the containment shell 132, the sleeve 156, and the magnet support body 116. The heat generation during operation of the pump 100, causing the overheating during dry operation of the pump 100, can be reduced by using the bushing and dampener assembly 120 including the dampener 124, thereby reducing vibration between the bushing 122 and the shaft 118 and its corresponding contribution to heat generation. For example, vibration associated with spinning of the impeller 114 and the magnet support body 116 can be reduced and/or isolated from the bushing 122 by the dampener 124 to prevent increased forces due to vibration from vibrating the bushing 122 relative to the impeller shaft 118. The increased forces can cause increased friction between the bushing 122 and the impeller shaft 118 which increases heat generation.

FIG. 2 illustrates an exploded view of a portion of the magnetic drive pump of FIG. 1. Impeller and bearing assembly 160 includes the impeller shaft 118, the magnet support body 116, the bushing and dampener assembly 120 including dampener 124 and bushing 122, and impeller 114.

Impeller shaft 118 is configured to provide a fixed shaft about which magnet support body 116 and impeller 114 rotate. The impeller shaft can be secured within a pump, for example using sleeves 154, 156 as described above and shown in FIG. 1.

Bushing and dampener assembly 120 is configured to provide a bearing between the impeller shaft 118 and the magnet support body 116. The bushing and dampener assembly 120 can provide a bearing allowing the magnet support body 116 to rotate relative to the impeller shaft 118, for example when the magnet support body 116 is being rotated by way of magnetic coupling to the magnetic drive housing 104, when the magnetic drive housing 104 is being rotated by the motor 101.

Dampener 124 is included in the bushing and dampener assembly 120. Dampener 124 can include a bore configured to receive the bushing 122, such that the dampener 124 can be provided over at least a portion of the bushing 122. Dampener 124 can be received in the magnet support body 116 such that the dampener 124 rotates with magnet support body 116. The dampener 124 includes or is formed entirely of an elastomer. The elastomer of the dampener 124 can have a hardness that is less than a hardness of the polymer material of the magnet support body 116. In an embodiment, the elastomer has a Shore A hardness in a range from 40 to 60. In an embodiment, the elastomer has a Shore A hardness in a range from 60 to 70. In an embodiment, the elastomer has a Shore A hardness in a range from 50 to 60. Non-limiting examples of the elastomer include silicone, a fluoroelastomer such as FKM, or the like. The elastomer can be selected for resistance to damage or degradation by the fluid being pumped. Dampener 124 can have an annular projection 164 formed on an inner surface thereof, as shown in FIG. 3. Additionally or alternatively to the annular projection 164, the dampener 124 can include any suitable features for interfacing with the bushing 122, such as one or more projections or recesses, or the like. Dampener 124 can reduce the effect of vibration on the generation of heat from friction at the bearing surface of the bushing and dampener assembly 120. For example, the dampener 124 can be configured to resist friction enhancing relative vibration between the impeller shaft and the bushing 122. The reduced heat generation can reduce the risk of damage to the pump 100 when the pump 100 is operated without suitable cooling, for example when the pump 100 is operated in a dry state.

Bushing 122 can be included in bushing and dampener assembly 120 to provide the bearing surface with impeller shaft 118. The bushing 122 can provide bearing surfaces on an inner surface of the bushing 122, facing the impeller shaft 118. The bearing surfaces can provide a bearing allowing bushing 122, dampener 124, and magnet support body 116 to rotate relative to the impeller shaft 118. Bushing 122 can be provided between the impeller shaft 118 and the magnet support body 116. The bushing 122 can include a bore configured to accommodate the impeller shaft 118. The bushing 122 can be surrounded by the dampener 124. Contact between the dampener 124 and bushing 122 can allow the dampener 124 and the bushing 122 to rotate together about the impeller shaft 118. In an embodiment, bushing 122 does not directly contact the magnet support body 116 at any point. The bushing 122 can include one or more features configured to engage the dampener 124 to retain the bushing 122 and the dampener 124 together. Examples of such features include a circumferential groove 162 on an outer surface of the bushing 122. The circumferential groove 162 can be configured to interface with an annular projection 164 provided on an inner surface of the dampener 124, as shown in FIG. 3 and described below. Other non-limiting examples of features for engaging the dampener 124 can include projections, recesses, or the like formed on an outer surface of the bushing 122. Bushing 122 can be formed of any suitable material, with non-limiting examples including ceramic, carbon graphite, polymer materials, combinations thereof, or the like. In an embodiment, the bushing 122 is formed of carbon graphite.

Magnet support body 116 is configured to be magnetically coupled to a magnetic drive housing 104, such that rotation of the magnetic drive housing 104 can drive corresponding rotation of the magnet support body 116. Magnet support body 116 is configured to couple with the impeller 114, for example through one or more coupling features 166, such that when magnet support body 116 is rotated by the magnetic coupling to magnetic drive housing 104, the magnet support body 116 in turn drives rotation of the impeller 114. The magnets 112 of the magnet support body 116 can be contained within the magnet support body 116, visible in the sectional views of FIGS. 1 and 3. Magnet support body 116 can be formed of a polymer material.

Impeller 114 is configured to be coupled to the magnet support body 116 so as to be rotated by the rotation of the magnet support body 116 about the impeller shaft 118. The impeller 114 includes blades configured to drive the flow through pump 100 from the inlet 126 to the outlet 127. The impeller 114 can include engagement features configured to provide the coupling with the magnet support body 116, for example alternating recesses 168 and projections 170 corresponding to the coupling features 166 provided on magnet support body 116.

FIG. 3 illustrates a cross-sectional view of a portion of the magnetic drive pump of FIG. 1. In the sectional view of FIG. 3, the annular projection 164 of the dampener 124, configured to be received in circumferential groove 162 of the bushing 122, can be seen. The interface between the projection 164 and circumferential groove 162 can secure the dampener 124 and the bushing 122 together to resist or prevent relative movement between the dampener 124 and the bushing 122 along the axis of rotation 108. It is understood that any other suitable interfacing features on the bushing 122 and the dampener 124 can be used instead of or in addition to the circumferential groove 162 and projection 164 shown in FIG. 3.

In the sectional view of FIG. 3, the magnets 112 of the magnet arrangement 110 can be seen inside the magnet support body 116. The magnets 112 can be included in compartments provided in the magnet support body, or any other suitable arrangement for providing the magnets 112 on or in the magnet support body 116, such that the magnets 112 can magnetically couple the magnet support body to the magnetic drive housing 104 as described above and shown in FIG. 1.

FIG. 4 illustrates a perspective view of a portion of the magnetic drive pump of FIG. 1. Pump 100 includes inlet 126 and outlet 127. Inlet 126 is an axial inlet having an axis that aligns with the axis of rotation 108. Outlet 127 is a radial outlet having an axis that is radially oriented relative to the axis of rotation 108. As previously described, the pump 100 includes a pump housing including the main housing body 128. The inlet 126 and the outlet 127 are defined by the main housing body 128. The main housing body 128 can be formed of a polymer material, for example being formed of molded plastic.

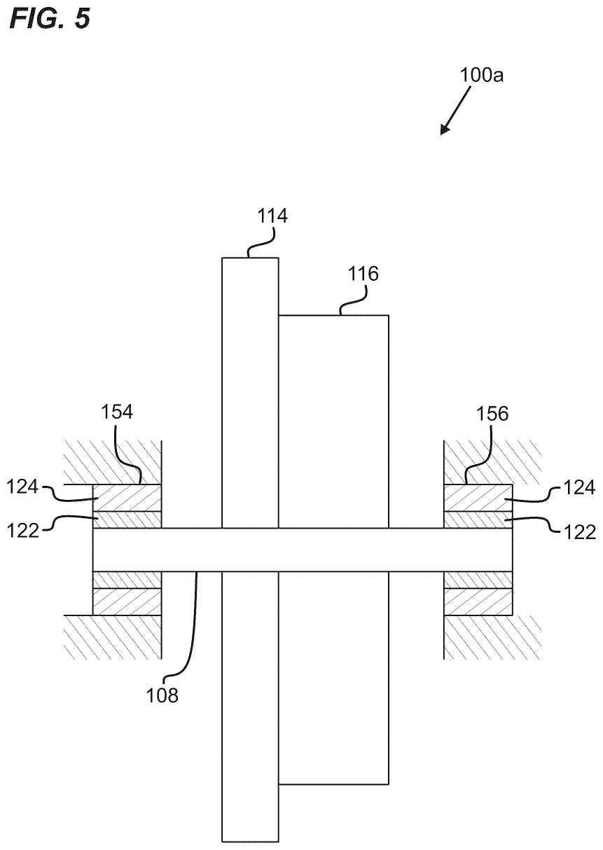

FIG. 5 depicts an alternative magnetic drive pump 100a in accordance with the principles of the present disclosure which has the same basic construction as the pump 100 except the impeller shaft 118 is configured to rotate relative to the pump housing and the impeller 114 and the magnet support body 116 are fixed with respect to the impeller shaft 118 such that the impeller 114 and the magnet support body 116 are adapted to rotate in unison with the impeller shaft 118 as the impeller shaft 118 rotates relative to the pump housing about the axis 108. The ends of the impeller shaft 118 are rotatably supported within bushings 122 that are coupled to the pump housing by elastomeric dampeners 124. As depicted at FIG. 5, the dampeners 124 are supported within the sleeves 154 and 156 included as part of the pump housing. The dampeners 124 allow the bushings 122 to move radially relative to the housing to resist vibration between the shaft 118 and the bushings 122. In an alternative example, a dampener that rotates in unison with the impeller 114 and the shaft 118 can be provided between the rotatable shaft 118 and the impeller 114 rather than between the bushings 122 and the pump housing. In this example, the bushings could be supported directly by the pump housing.

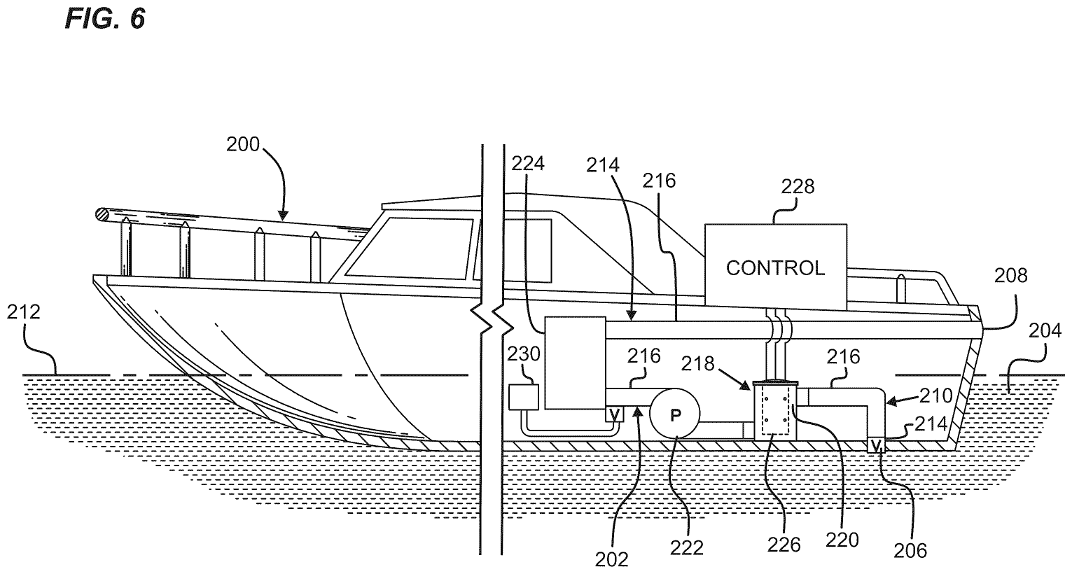

FIG. 6 illustrates a watercraft 200 having an on-board water system 202 including a pumping system in accordance with the principles of the present disclosure. The watercraft 200 is shown supported on a body of water 204. The on-board water system 202 includes an inlet 206, an outlet 208, and a water flow path 210 that extends from the inlet 206 through the watercraft 200 to the outlet 208. The inlet 206 is configured for drawing water from the body of water 204 into the water flow path 210. The inlet 206 is located below a water line 212 of the watercraft 200 and is preferably located at a bottom of the hull of the watercraft 200. The inlet 206 can be opened and closed by a valve 214 such as a seacock. The outlet 208 is configured for discharging water that has passed through the water flow path 210 back to the body of water 204. Preferably, the outlet 208 is positioned above the water line 212. The on-board water system 202 can include a plurality of components positioned along the water flow path 210. The water flow path 210 can include a plurality of conduits 216 (e.g., hoses, tubes, pipes, etc.) which extend between the components of the on-board water system 202 and function to carry water along the water flow path 210 between the various components. As shown at FIG. 6 the depicted components include a flow-through housing 218 enclosing water strainer 220, a pump 222, and one or more systems and/or equipment 224 that make use of water conveyed through the water flow path 210.

In the depicted example, an electrolytic cell 226 is integrated with the housing 218, for example within the strainer 220. The electrolytic cell 226 can interface with a control unit 228 (e.g., controller). The electrolytic cell 226 can be adapted for generating a biocide (e.g., chlorine or a chlorine derivative) within the water of the water flow path 210 while the water passes through the housing 218. The biocide is configured for inhibiting biofouling within the conduits 216 and within one or more of the components positioned along the water flow path 210. It will be appreciated that the biocide can also be referred to as a disinfecting agent or a cleaning agent since the biocide can also include disinfecting and cleaning properties. Further details about electrolytic cells that can be used in the water system are disclosed by PCT International Publication Number WO 2019/070877, which is hereby incorporated by reference in its entirety.

It will be appreciated that examples of the type of the systems and/or equipment 224 can include cooling systems such as air conditioners or chillers where water drawn from the body of water 204 can be used as a cooling media for cooling refrigerant of the cooling systems (e.g., within a heat exchanger or heat exchangers). In other examples, the water from the water flow path 210 can be used to provide engine cooling. In other examples, water from the water flow path 210 can be used for sanitation systems or watercraft propulsion systems. Example water systems can also include a potable water system 230 for providing drinking water (drinking water systems often include reverse osmosis filtration systems), shower water, water for faucets, or other potable water uses on the water vessel. Additionally, water from the water flow path 210 can be used for live well systems to fill live wells for holding bait on the watercraft 200. In certain examples, the electrolytic cell 226 can be deactivated when water is directed to the potable water system 230, a live well system, or the like.

While pumps in accordance with the principles of the present disclosure have been shown in watercraft type systems, it will be appreciated that such pumps can also be use in other applications such as industrial applications and can be used to pump liquids other than sea water (e.g., industrial liquids, waste-water, caustic liquids, corrosive liquids, solvents, mining liquids, electroplating liquids, semi-conductor processing liquids, acids (e.g., Citric Acid, Hydrochloric Acid, etc.), alcohols (e.g., Isopropyl, Methyl, etc.) cleaning solutions, plating solutions, etc.).

The various examples described above are provided by way of illustration only and should not be construed to limit the scope of the present disclosure. Those skilled in the art will readily recognize various modifications and changes that may be made with respect to the examples illustrated and described herein without departing from the true spirit and scope of the present disclosure.

What is claimed is:

1. A magnetic drive pump, comprising:
an impeller shaft defining an axis of rotation;
a magnetically driven assembly configured to rotate about the axis of rotation, the magnetically driven assembly including an impeller and a first magnet;
a bushing positioned on the impeller shaft for supporting rotation of the magnetically driven assembly about the axis of rotation; and
an elastomeric dampener for resisting relative vibrational movement between the impeller shaft and the bushing.

2. The magnetic drive pump of claim 1, wherein the impeller and the first magnet are adapted to rotate about the impeller shaft, wherein the bushing and the elastomeric dampener are configured to rotate about the impeller shaft in unison with the impeller and the first magnet, and wherein the elastomeric dampener is disposed between the bushing and the impeller.

3. The magnetic drive pump of claim 2, wherein the magnetically driven assembly includes a magnet support body to which the first magnet is secured, the magnet support body being coupled with respect to the impeller such that the impeller and the magnet support body rotate together about the impeller shaft.

4. The magnetic drive pump of claim 3, wherein the magnet support body is the elastomeric dampener.

5. The magnetic drive pump of claim 3, wherein the elastomeric dampener is positioned between the bushing and the magnet support body.

6. The magnetic drive pump of claim 5, wherein the magnet support body and the impeller are constructed of a material that is harder than a material of the elastomeric dampener.

7. The magnetic drive pump of claim 6, wherein the magnet support body and the impeller each have molded polymeric construction.

8. The magnetic drive pump of claim 1, wherein the elastomeric dampener has a hardness that is less than a hardness of a material of which the impeller is constructed.

9. The magnetic drive pump of claim 1, wherein the elastomeric dampener has a Shore A hardness in a range from 40 to 90.

10. The magnetic drive pump of claim 5, wherein the bushing includes a circumferential groove and the elastomeric dampener includes a circumferential projection configured to be received in the circumferential groove.

11. The magnetic drive pump of claim 1, wherein the bushing is formed of carbon graphite.

12. The magnetic drive pump of claim 1, wherein the elastomeric dampener has a construction including a silicone elastomer.

13. The magnetic drive pump of claim 1, wherein the elastomeric dampener has a construction including a fluoroelastomer.

14. The magnetic drive pump of claim 13, wherein the fluoroelastomer is FKM.

15. The magnetic drive pump of claim 1, further comprising:
a magnetic drive housing having a second magnet disposed on or in the magnetic drive housing;
a drive shaft, configured to drive rotation of the magnetic drive housing,
wherein the second magnet magnetically couples with the first magnet such that when the magnetic drive housing is rotated by the drive shaft the magnetically driven assembly is driven to rotate about the impeller shaft.

16. The magnetic drive pump of claim 15, further comprising a containment shell mechanically isolating magnetically driven assembly the from the magnetic drive housing.

17. The magnetic drive pump of claim 16, wherein the containment shell is sealed to a main housing body, the main housing body accommodating the impeller.

18. The magnetic drive pump of claim 17, wherein the containment shell is sealed to a cover that attaches to the main housing body, wherein the cover defines an opening through which a sleeve of the containment shell projects, wherein the first magnet is positioned within the sleeve and the second magnet is positioned about an exterior of the sleeve.

19. The magnetic drive pump of claim 1, wherein the magnetic drive pump is a water pump.

20. The magnetic drive pump of claim 1, wherein the magnetic drive pump is a marine grade water pump.

21. The magnetic drive pump of claim 1, wherein the magnetic drive pump is a water pump adapted for pumping sea water.

22. A water pump system including the magnetic drive pump of claim 1.

23. A watercraft including the water pump system of claim 22.

24. The magnetic drive pump of claim 1, further comprising a pump housing, wherein the impeller and the first magnet are adapted to rotate with the impeller shaft about the axis of rotation, wherein the impeller shaft is configured to rotate relative to the bushing and the elastomeric dampener about the axis or rotation, wherein the bushing is supported by the pump housing, and wherein the elastomeric dampener is positioned between the bushing and the pump housing.

25. The magnetic drive pump of claim 3, wherein the first magnet is one of a plurality of first magnets positioned circumferentially about the axis of rotation, or wherein the first magnet is a multipole ring magnet.

26. The magnetic drive pump of claim 15, wherein the first magnet is one of a plurality of first magnets positioned circumferentially about the axis of rotation or a first multipole ring magnet, and wherein the second magnet is one of a plurality of second magnets positioned circumferentially about the axis of rotation or a second multipole ring magnet.

27. The magnetic drive pump of claim 1, wherein the bushing and the elastomeric dampener are positioned in the magnetic drive pump such that the bushing and the elastomeric dampener are exposed to fluid being pumped by the magnetic drive pump.

28. The magnetic drive pump of claim 1, wherein the elastomeric dampener is disposed between the bushing and the impeller.

29. The magnetic drive pump of claim 1, wherein the elastomeric dampener is disposed between the impeller shaft and a part of a pump housing of the magnetic driven pump.
